(19) United States
(12) Patent Application Publication
(10) Pub. No.: US 2025/0341813 A1
(43) Pub. Date: Nov. 6, 2025

(54) DATA PROCESSING DEVICE, DATA PROCESSING METHOD, AND COMPUTER READABLE MEDIUM

(71) Applicant: Mitsubishi Electric Corporation, Tokyo (JP)

(72) Inventors: Satoshi NOGUCHI, Tokyo (JP); Takaaki ABE, Tokyo (JP)

(73) Assignee: Mitsubishi Electric Corporation, Tokyo (JP)

(21) Appl. No.: 19/271,107

(22) Filed: Jul. 16, 2025

Related U.S. Application Data
(63) Continuation of application No. PCT/JP2023/010766, filed on Mar. 17, 2023.

(51) Int. Cl. G05B 19/05

(52) U.S. Cl. CPC G05B 19/056; G05B 2219/13009

(57) ABSTRACT

A control procedure data acquisition unit (101) acquires control procedure data (200) that indicates control procedures using a plurality of conditions that are ordered and a plurality of control variables, each of which is associated with any of the plurality of conditions, and to which a value is assigned depending on success or failure of an associated condition being the condition that is associated. The program management unit (102) selects each condition, and generates, for each selected condition that is selected, a state determination block to decide a value of the state variable of the selected condition based on success or failure of the selected condition and a value of a state variable of a preceding condition with an order prior to the selected condition. The program management unit (102) selects each control variable, and generates, for each selected control variable that is selected, a control execution block to decide a value to be assigned to the selected control variable based on a value of a state variable of the associated condition for the selected control variable. Furthermore, the program management unit (102) generates a control program (300) that reflects the control procedures using the state determination block and the control execution block.

### CROSS REFERENCE TO RELATED APPLICATIONS

This application is a Continuation of PCT International Application No. PCT/JP2023/010766, filed on Mar. 17, 2023, which is hereby expressly incorporated by reference into the present application.

### TECHNICAL FIELD

The present disclosure relates to generation of a program.

### BACKGROUND ART

The present disclosure primarily describes generation of a control program (hereinafter, simply referred to as a program) used predominantly in manufacturing equipment, etc.

Manufacturing equipment is controlled by controllers such as a PLC (Programmable Logic Controller). The details of control vary depending on each manufacturing equipment. Therefore, the developers of manufacturing equipment and/or apparatuses to configure the manufacturing equipment develop a program in accordance with their control specification. The PLC program often utilizes a language prescribed mainly in IEC61131-3, and above all, ladder language is most commonly used.

As manufacturing equipment becomes more complex, the program volume of the PLC program increases, resulting in increase in development man-hours. To support the development of the PLC program, there exist technologies disclosed in Patent Literature 1 through 3, for example.

### CITATION LIST

### Patent Literature

Patent Literature 1: JP 3426405 B

Patent Literature 2: JP Hei5-173609 A

Patent Literature 3: JP 2021-149853 A

### SUMMARY OF INVENTION

### Technical Problem

When a problem occurs in manufacturing equipment, the maintenance workers of the manufacturing equipment often check the program to identify the cause. For instance, the maintenance workers check the value of each variable in the program when the problem occurs. Therefore, the program of the control equipment is required to be created to be easily understood even by those other than program developers in addition to functioning according to the requirement specifications.

In terms of program notation using ladder language, state-transition notation (Reference 1) and step control notation (Reference 2) are sometimes used. Hereinafter, both will be referred to collectively as state-transition notation.
Reference 1: Guidebook for collection of standard practices of sequence control programs using PLC, sequence, PLC, control, mechatronics/book, magazine, THE NIKKAN KOGYO SHINBUN, LTD. (nikkan.co.jp)
Reference 2: Stepping control/Sequence control lesson (plckouza.com)

A program written in the state transition notation, as illustrated in FIG. 17, is configured by a state determination block and a control execution block. The state determination block is a code block that stores the status of progression of sequential operations one by one in variables according to changes in the state. The control execution block is a code block that switches output processing in accordance with each state.

In the example of FIG. 17, the values of the state variables M0 through M3 in the state determination block indicate states. Further, the values of the conditional variables X0, X1, and X2 indicate the success or failure of the transition condition. Then, the values of the state variables M1 through M3 become ON sequentially as the values of the conditional variables X0, X1, and X2 become ON sequentially. When the value of the state variable M3 becomes ON, all the values of the state variables MO through M3 become OFF, and the processing returns to the initial state.

Meanwhile, in the control execution block, the output variable Y10 indicates an output value to the control target. When the value of the state variable M1 becomes ON, the value of the output variable Y10 becomes ON. On the other hand, when the value of the state variable M2 becomes ON, the value of the output variable Y10 becomes OFF.

In addition, as a similar notation method, event control notation (Reference 1) may be used. A program written in the event control notation is also composed of a state determination block and a control execution block, as exemplified in FIG. 18. In a program written in the event control notation, events that sequentially occur are determined, and outputs are controlled depending on the determination results of the events.

The differences between the state transition notation and the event control notation are as follows.

In a program using the state transition notation, all state variable values M0 through M3 become OFF after reaching the final state. In contrast, in a program using the event control notation, the previous state turns OFF when the state changes. In the example of FIG. 18, when the value of the state variable M1 becomes ON, the value of the state variable M0 becomes OFF. Additionally, when the value of the state variable M2 becomes ON, the value of the state variable M1 becomes OFF. Further, when the value of the state variable M3 becomes OFF, the value of the state variable M2 becomes ON. Furthermore, when the value of the state variable M0 becomes ON, the value of the state variable M3 becomes OFF.

The state transition notation and the event control notation are used properly depending on the purpose and field of manufacturing equipment, etc.

Currently, there is no established method to describe a program easily using the state transition notation and the event control notation as described above.

Because of this, developers who develop programs need to create all programs according to the control procedures, thereby there exists a problem of increased development man-hours.

The present disclosure is aiming primarily at solving the problem. More specifically, the present disclosure is aiming primarily at reducing development man-hours in generation of a program.

### Solution to Problem

There is provided according to one aspect of the present disclosure a data processing device includes
a control procedure data acquisition unit to acquire control procedure data indicating a control procedure using a plurality of conditions that are ordered, and a plurality of control variables, each of which is associated with any of the plurality of conditions, and to which a value is assigned depending on success or failure of an associated condition being the condition that is associated;
a first partial program generation unit to sequentially select each condition of the plurality of conditions, and to generate, for each selected condition being the condition selected, a first partial program to decide a value of a state variable of the selected condition based on success or failure of the selected condition and a value of a state variable of a preceding condition being a condition with an order prior to the selected condition, in accordance with the control procedure;
a second partial program generation unit to sequentially select each control variable of the plurality of control variables, and to generate, for each selected control variable being the control variable selected, a second partial program to decide a value to be assigned to the selected control variable based on a value of a state variable of the associated condition for the selected control variable, in accordance with the control procedure; and
a program generation unit to generate a program that reflects the control procedure using the first partial program and the second partial program.

### Advantageous Effects of Invention

According to the present disclosure, it is possible to generate a program reflecting control procedures, thereby reducing development man-hours.

### BRIEF DESCRIPTION OF DRAWINGS

FIG. 1 is a diagram illustrating an example of a functional configuration of a data processing device according to First Embodiment;

FIG. 2 is a diagram illustrating an example of a hardware configuration of the data processing device according to First Embodiment;

FIG. 3 is a diagram illustrating an example of controlling a control target according to First Embodiment;

FIG. 4 is a diagram illustrating an example of control procedure data according to First Embodiment;

FIG. 5 is a diagram illustrating an example of control program according to First Embodiment;

FIG. 6 is a flowchart illustrating an operation example of a program management unit according to First Embodiment;

FIG. 7 is a diagram illustrating an example of a part of the control program according to First Embodiment;

FIG. 8 is a diagram illustrating an example of a part of the control program according to First Embodiment;

FIG. 9 is a diagram illustrating an example of a part of the control program according to First Embodiment;

FIG. 10 is a diagram illustrating an example of a control program according to Second Embodiment;

FIG. 11 is a diagram illustrating an example of a control program according to Second Embodiment;

FIG. 12 is a diagram illustrating an example of a control program according to Third Embodiment;

FIG. 13 is a flowchart illustrating an operation example of a program management unit according to Third Embodiment;

FIG. 14 is a diagram illustrating an example of control procedure data according to Fourth Embodiment;

FIG. 15 is a diagram illustrating an example of a control program according to Fourth Embodiment;

FIG. 16 is a flowchart illustrating an operation example of a program management unit according to Fourth Embodiment;

FIG. 17 is a diagram illustrating an example of a control program in state transition notation; and

FIG. 18 is a diagram illustrating an example of a control program in event control notation.

### DESCRIPTION OF EMBODIMENTS

Hereinafter, embodiments will be described using diagrams. In the following explanation and drawings of the embodiments, the same or equivalent parts are denoted by the same reference numerals.

### First Embodiment

### *** Description of Configuration ***

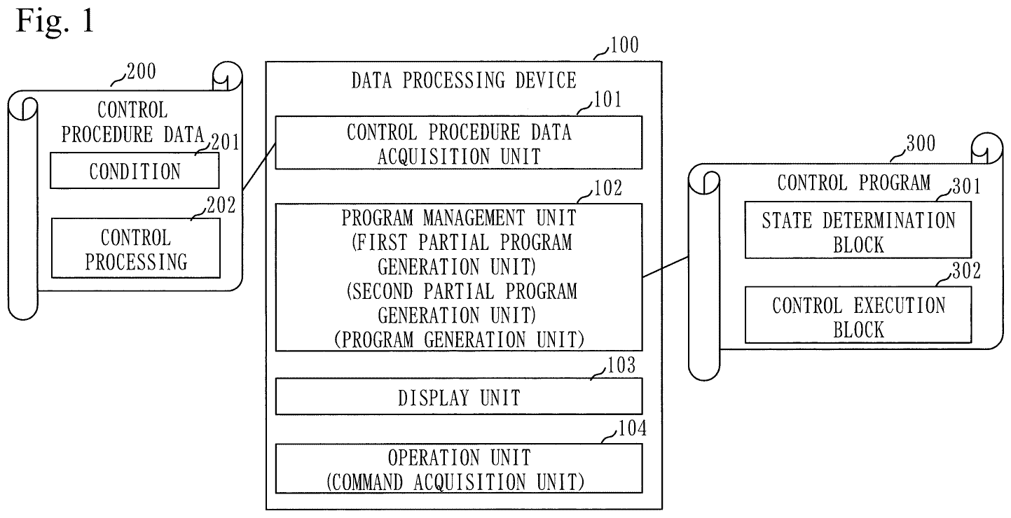

FIG. 1 illustrates an example of a functional configuration of a data processing device 100 according to the present embodiment.

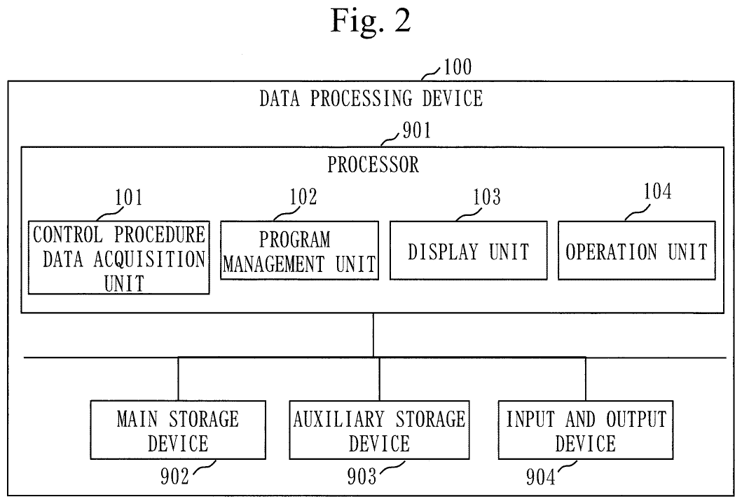

Further, FIG. 2 illustrates an example of a hardware configuration of the data processing device 100 according to the present embodiment.

The operation procedure of the data processing device 100 corresponds to a data processing method. Further, the program that realizes the operation of the data processing device 100 corresponds to a data processing program.

The data processing device 100 is a computer.

As illustrated in FIG. 2, the data processing device 100 includes a processor 901, a main storage device 902, an auxiliary storage device 903 and a communication device, as hardware components.

Additionally, as illustrated in FIG. 1, the data processing device 100 includes a control procedure data acquisition unit 101, a program management unit 102, a display unit 103 and an operation unit 104 as the functional configuration. The functions of the control procedure data acquisition unit 101, the program management unit 102, the display unit 103 and the operation unit 104 are realized, for example, by programs.

The auxiliary storage device 903 stores programs to realize the functions of the control procedure data acquisition unit 101, the program management unit 102, the display unit 103 and the operation unit 104.

These programs are loaded from the auxiliary storage device 903 into the main storage device 902. Then, the processor 901 executes these programs, performing the operations of the control procedure data acquisition unit 101, the program management unit 102, the display unit 103 and the operation unit 104, which will be described later.

FIG. 2 schematically illustrates a state where the processor 901 executes the programs to realize the functions of the control procedure data acquisition unit 101, the program management unit 102, the display unit 103 and the operation unit 104.

In FIG. 1, the control procedure data acquisition unit 101 acquires control procedure data 200.

The control procedure data 200 is data which describes the control procedure. The control procedure data 200 includes conditions 201 and control processes 202. Details of the control procedure data 200 will be described later.

The processing performed by the control procedure data acquisition unit 101 corresponds to a control procedure data acquisition process.

The program management unit 102 analyses the control procedure data 200 to generate a control program 300. The control program 300 is a program that reflects the control procedure described in the control procedure data 200. The control program 300 includes a state determination block 301 and a control execution block 302. Details of the control program 300 will be described later.

The program management unit 102 corresponds to a first partial program generation unit, a second partial program generation unit and a program generation unit.

Further, the processes performed by the program management unit 102 correspond to a first partial program generation process, a second partial program generation process and a program generation process.

The display unit 103 displays various information to the user of the data processing device 100. Additionally, the display unit 103 may also display the control program 300 generated.

The operation unit 104 accepts operations from the user of the data processing device 100.

The operation unit 104 corresponds to a command acquisition unit.

Next, the control procedure data 200 will be described.

The control procedure data 200 is composed of conditions 201 and control processes 202. The control procedure data 200 includes a plurality of conditions 201 and a plurality of control processes 202, and the plurality of conditions 201 are ordered. Each control process 202 is an assignment process of variable values to control variables, an arithmetic operation process and the like. The control variable is a variable to which variable values for controlling a control target are assigned. The control variable can be, for example, an output variable. Each control variable is associated with any of the conditions among the plurality of the conditions 201. Further, variable values according to success or failure of associated conditions being conditions that are associated are assigned to each control variable. In the control procedure data 200, control procedures are described using the plurality of conditions 201 and the plurality of control processes 202 (assignment process of variable values to control variables).

Unless otherwise specified, the control variables are assumed to be output variables in the following.

Hereinafter, the control procedure data 200 will be described using specific examples.

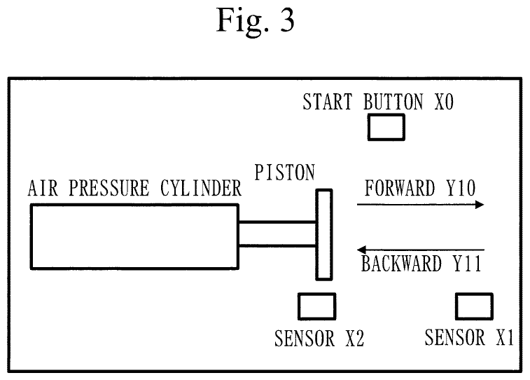

FIG. 3 illustrates a control procedure for an air pressure cylinder being the control target.

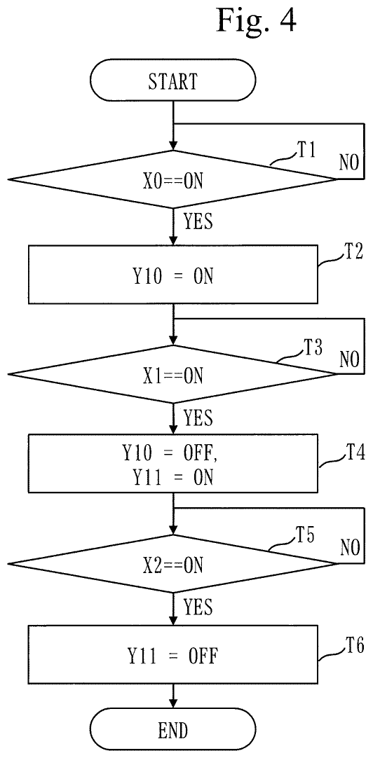

Further, FIG. 4 illustrates an example of the control procedure data 200 describing the control procedure in FIG. 3.

In the example of FIG. 3, when a start button is pressed, the value of conditional variable X0 becomes ON.

When the value of conditional variable X0 turns ON, the value of output variable Y10 becomes ON.

When the value of output variable Y10 becomes ON, a piston inside the air pressure cylinder starts moving forward by an instruction from a PLC.

When a sensor X1 reacts to the tip of the piston, the value of conditional variable X1 turns ON.

When the value of conditional variable X1 turns ON, the value of output variable Y10 turns OFF.

When the value of output variable Y10 becomes OFF, the piston stops moving forward by an instruction from the PLC.

Following this, the output variable Y11 turns ON.

When the output variable Y11 turns ON, the piston starts moving backward by an instruction from the PLC.

Then, when a sensor X2 reacts to the tip of the piston, the conditional variable X2 turns ON.

When the conditional variable X2 turns ON, the value of output variable Y11 becomes OFF.

When the value of output variable Y11 becomes OFF, the piston stops movement by an instruction from the PLC.

In the example of FIG. 4, the control procedure is described in a flowchart format. In the example of FIG. 4, the conditions 201 are represented by determination objects (diamond-shaped objects). Further, the control processes 202 are represented by processing objects (rectangular objects). Then, the control procedure is expressed by connecting objects with arrows.

In other words, in the example of FIG. 4, each of “X0==ON”, “X1==ON” and “X2==ON” indicated in the determination objects is a condition 201. In addition, each of “X0”, “X1” and “X2” included in the conditions 201 is a conditional variable. Further, each of “Y10=ON”, “Y10=OFF”, “Y11=ON” and “Y11=OFF” indicated in the processing objects is a control process 202. Each of “Y10” and “Y11” to which variable values (ON or OFF) are assigned in the control process 202 is an output variable.

Note that in the example of FIG. 4, it is described in one processing object (stepT4) that “Y11=ON” is performed after “Y10=OFF”. Instead, it may be possible to describe “Y10 32 OFF” and “Y11=ON” in separate processing objects, and to connect these processing objects with arrows.

Similarly, it may be possible to describe a plurality of conditions connected with AND operation (AND) in one determination object, or to describe each condition in separate determination objects and to connect these determination objects with arrows. Further, a plurality of conditions may be described in other methods.

In the control procedure data 200, it is enough if the order of the conditions 201 and the control processes 202 are merely presented. For this reason, the control procedure data 200 may be generated in a structured language such as XML (Extensible Markup Language) instead of flowcharts. Furthermore, the control procedure data 200 may be generated in a tabular form, such as a spreadsheet.

Additionally, in the example of FIG. 4, a flowchart is created using variables X0, Y10, etc., that indicate PLC input and output addresses; however, a flowchart may also be created using names that can be easily understood, such as “sensor A”. In this case, description of “sensor A==ON”, etc. is used instead of “X0==ON”, etc. Further, it may be possible to generate the control program 300 by preparing a correspondence table of names and input and output addresses used in flowcharts separately, and by converting the names into the input and output addresses using the correspondence table. Furthermore, when software involving ladder language corresponds to a program using variables, it may be possible to generate the control program 300 by using names such as “sensor A” as variable names. In this case, a correspondence table of variable names and input and output addresses is also created.

Next, the control program 300 illustrated in FIG. 1 will be described.

The control program 300 is composed of a state determination block 301 and a control execution block 302.

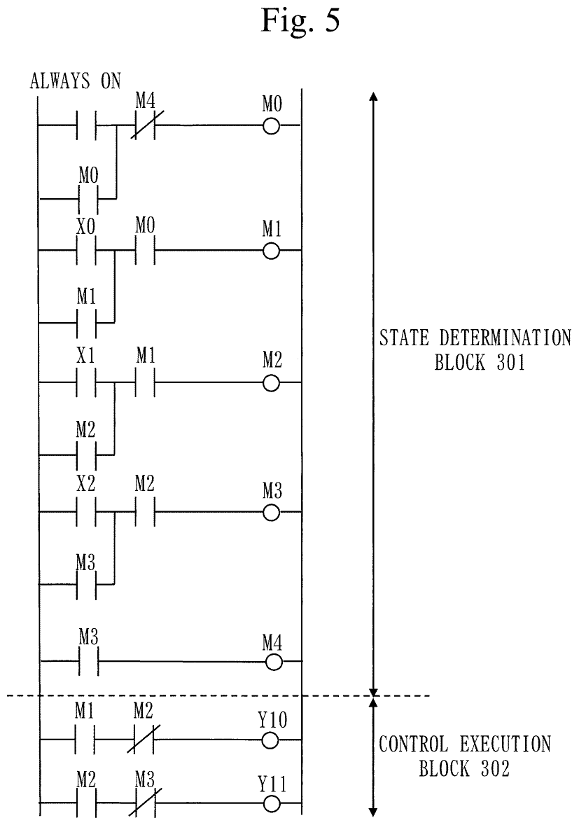

FIG. 5 illustrates an example of the control program 300 that is generated from the control procedure data 200 illustrated in FIG. 4.

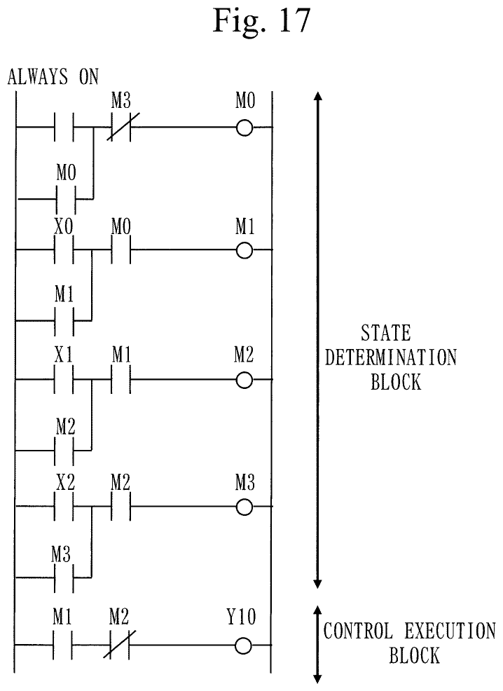

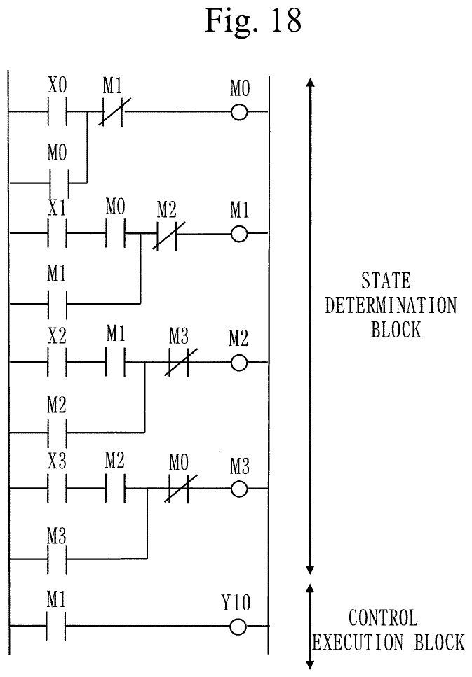

The state determination block 301 is a code block that stores the status of progression of sequential operations one by one in variables according to changes in the state as explained in the description for FIG. 17. Each code block in each line illustrated above the dashed line in FIG. 5 is the state determination block 301. Each state determination block 301 corresponds to the first partial program.

Further, the control execution block 302 is also a code block that switches the output process according to each state as explained in the description for FIG. 17. Each code block in each line illustrated below the dashed line in FIG. 5 is the control execution block 302. Each control execution block 302 corresponds to the second partial program.

### *** Description of Operation ***

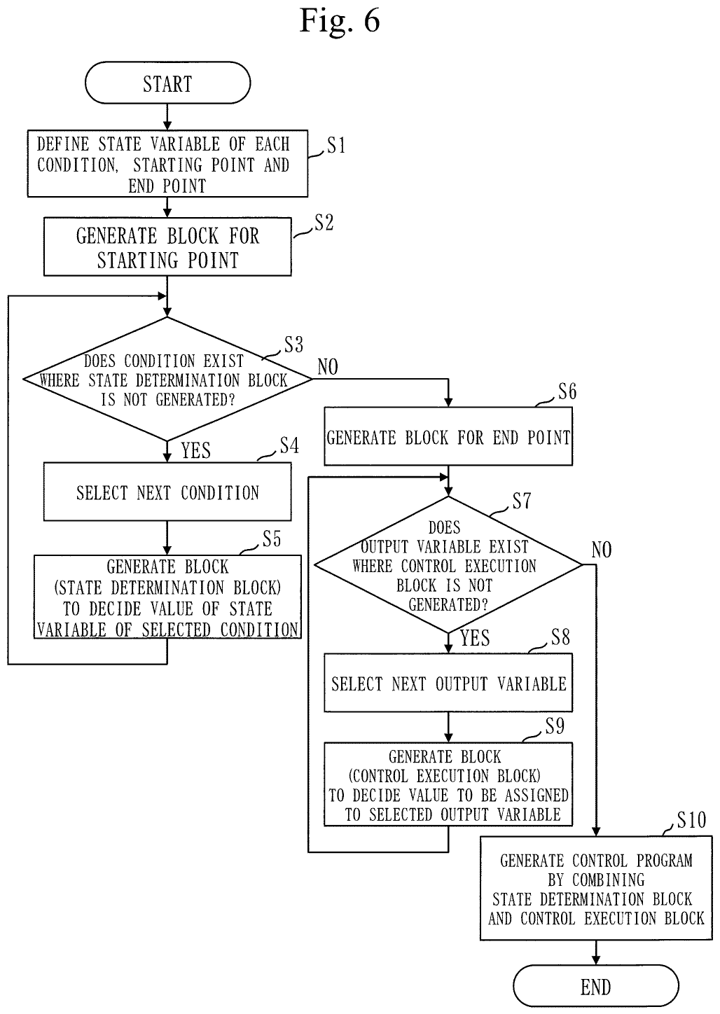

The operation example of the program management unit 102 according to the present embodiment will be described with reference to FIG. 6.

In the following, an example of generating the control program 300 illustrated in FIG. 5 from the control procedure data 200 illustrated in FIG. 4 will be used to describe the operation example of the program management unit 102.

FIG. 6 illustrates the operation after the control procedure data acquisition unit 101 has acquired the control procedure data 200 and output the control procedure data 200 acquired to the program management unit 102.

Firstly, the program management unit 102 defines state variables that correspond to each condition, a starting point, and an end point (Step S1).

In the example of FIG. 5, the program management unit 102 defines the state variable M0 for the starting point. Further, the program management unit 102 defines the state variable M1 for the condition “X0==ON”. Furthermore, the program management unit defines the state variable M2 for the condition “X1==ON”. Additionally, the program management unit 102 defines the state variable M3 for the condition “X2==ON”. Further, the program management unit 102 defines the state variable M4 for the end point.

The program management unit 102 may designate variable names of the state variables in the order defined in the control procedure data 200 as described above. Alternatively, the user of the data processing device 100 may designate variable names of the state variables in the control procedure data 200, for example.

Next, the program management unit 102 generates a code block (hereinafter referred to simply as a block) with respect to the starting point (Step S2).

Each code block generated from Step S2 through Step S6 to be described below corresponds to the state determination block 301 (the first partial program).

In the example of FIG. 5, the program management unit 102 generates a code block with respect to the starting point, which turns OFF the value of state variable MO in the starting point only when the value of state variable M4 in the end point is ON, and otherwise, turns ON the value of the state variable M0. In this manner, the value of state variable M0 becomes OFF when the value of state variable M4 becomes ON due to the code block with respect to the end point generated in Step S6, which will be described later. Then, the values of the other state variables M1 through M4 become OFF sequentially. As a result, the processing returns to the initial condition (values of all state variables are OFF).

In the example of FIG. 3, as determination on the success or failure of the start condition, determination on whether the piston is at the initial position is omitted. Instead, determination on whether the piston is at the initial position may be included, and the program management unit 102 may add a state variable for determining whether the piston is at the initial position into the code block with respect to the starting point. Additionally, the program management unit 102 may generate a code block that determines whether the piston is at the initial position as the first condition.

Next, the program management unit 102 determines whether or not there exists a condition where the state determination block 301 is not generated (Step S3).

If there exists a condition where the state determination block 301 is not generated (YES in Step S3), the process proceeds to step S4. On the other hand, if the state determination blocks 301 are generated for all conditions (NO in Step S3), the process proceeds to Step S6.

In Step S4, the program management unit 102 selects the next condition.

More specifically, in Step S4 immediately after Step S2, the program management unit 102 selects the first condition in the control procedure data 200. Meanwhile, if the state determination block 301 has been already generated for any conditions, the program management unit 102 selects the next condition in the control procedure data 200 of the condition being the target for generation in the state determination block 301 immediately before.

The program management unit 102 is assumed to select the condition “X0==ON” being the first condition in the control procedure data 200 as illustrated in FIG. 5.

Next, according to the control procedure, the program management unit 102 generates a block (state determination block 301) that decides the value of the state variable (M1) of the selected condition (“X0==ON) that is selected (Step S5).

Specifically, the program management unit 102 generates a code block to decide the value (ON/OFF) of the state variable (M1) of the selected condition based on the success or failure of the selected condition (“X0==ON”), the value of the state variable (state variable M0 in the starting point) of a preceding condition with the order prior to the selected condition, the value of the state variable (M1) of the selected condition, and a condition by which the state variable (M1) of the selected condition is not established.

Here, the program management unit 102 uses only the condition with the order immediately prior to the selected condition as the preceding condition. The program management unit 102 may use a condition with an order other than immediately prior to the selected condition as well as the condition with the order immediately prior to the selected condition as long as it is the condition with the order prior to the selected condition.

The condition by which the state variable of the selected condition is not established is a condition that makes the value of the state variable of the selected condition become OFF. Further, here, the data processing device 100 or the control procedure data 200a is supposed to have a definition that the condition by which the state variable of the selected condition is not established is the value of the state variable of the immediately preceding condition becoming OFF. Therefore, in the example of FIG. 5, as the condition by which the state variable M1 is not established, the value of the state variable M0 being OFF is used.

The program management unit 102 generates a block that makes the value of the state variable M1 become ON when the value of the immediately preceding state variable M0 is ON and the condition “X0==ON” is established, and that makes the value of the state variable M1 become OFF when the value of the immediately preceding state variable M0 becomes OFF. Note that in the ladder language, when the condition on the left side becomes not established, the variable on the right side becomes OFF. Therefore, the program management unit 102 also generates self-holding program by the state variable M1 so as to remain the value of the state variable M1 ON even when the value of the conditional variable X0 becomes OFF after the value of the state variable M1 becomes ON.

The program management unit 102 performs Step S3 through Step S5 even for the condition “X1==ON” and the condition “X2==ON”, and generates a code block (state determination block 301) to decide values of the state variable M2 and the state variable M3.

In the above, as description is given to generation of the state determination block 301 of “X0==ON” being the first condition in the control procedure data 200, the state variable MO in the starting point is used as the state variable of the preceding condition. In generation of the state determination block 301 of the condition “X1==ON”, the state variable M1 of the condition “X0==ON” is used as the state variable of the preceding condition. Further, in generation of the state determination block 301 of the condition “X2==ON”, the state variable M2 of the condition “X1==ON” is used as the state variable of the preceding condition.

In the present embodiment, description is given to the state determination block 301 for simple conditions such as “X0==ON”. However, it is possible for the program management unit 102 to generate a state determination block 301 also for more complex conditions.

As a complex condition, it is possible to consider that a condition involving determination of whether the timer has expired is included in the control procedure data 200. When the condition involving the determination of whether the timer has expired is the selected condition, the program management unit 102 generates a state determination block 301 to decide the value of the state variable of the selected condition based on both the success or failure of the selected conditions depending on the result of determining whether the timer has expired, and the value of the state variable of the preceding condition.

Further, as another complex condition, it is possible to consider that a condition involving logical operations of a plurality of partial conditions is included in the control procedure data 200. When the condition involving the logical operations of plurality of partial conditions is the selected condition, the program management unit 102 generates a state determination block 301 to decide the value of the state variable of the selected condition based on both the success or failure of the selected condition depending on the results from the logical operations of the plurality of partial conditions, and the value of the state variable of the preceding condition.

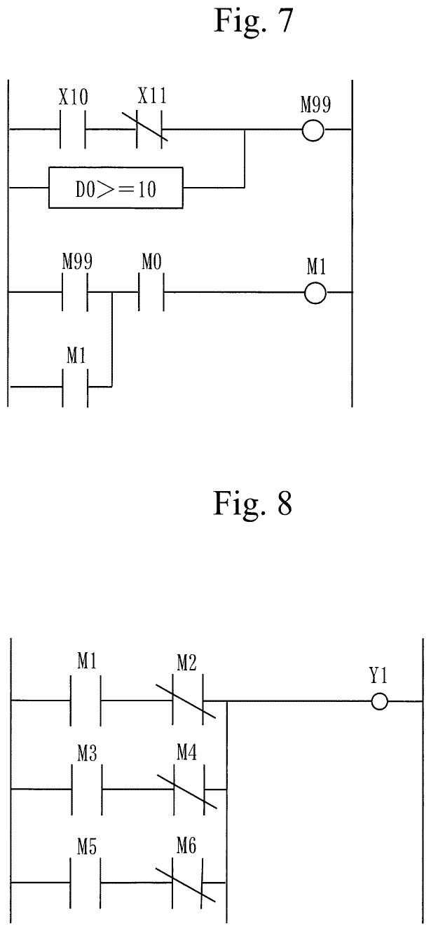

At this time, the program management unit 102 may generate a code block just to determine the condition, and generate the state determination block 301 to decide the value of the state variable using the determination result of that code block. For instance, suppose that a condition involving a logical operation such as “(X10==ON AND X11==OFF) OR D0>=10” is set instead of “X0==ON” in FIG. 4. In this case, as illustrated in FIG. 7, the program management unit 102 generates a code block to determine the success or failure of the said condition and assign the determination result to a variable M99. Then, the program management unit 102 generates a state determination block 301 to decide the value of the state variable M1 using the value of the variable M99.

In FIG. 6, once state determination blocks 301 are generated for all conditions (NO in Step S3), the program management unit 102 generates a code block (the state determination block 301) with respect to the end point (Step S6).

In the example of FIG. 5, the program management unit 102 generates a state determination block 301 where the value of the state variable M4 in the end point becomes ON when the value of the immediately preceding state variable M3 becomes ON.

By the value of state variable M4 becoming ON, the value of the state variable M0 becomes OFF. As a result, the values of the state variables M1 through M4 also sequentially become OFF, and the process returns to the initial state (values of all the state variables are OFF).

Next, the program management unit 102 generates a control execution block 302.

During maintenance of the manufacturing equipment, it is required to easily identify the cause for each output variable becoming its current value. For this reason, code blocks to decide the values of output variables (especially bit type variables) whose value often change are often described collectively for each output variable. Given these reasons, in the processing flow of FIG. 6, the program management unit 102 generates the control execution block 302 for each output variable. However, since there is no clear rule for the method to create the control program 300, the program management unit 102 may generate a code block (control execution block 302) to decide the values of output variables in accordance with their order of appearance in the control procedure data 200.

In FIG. 6, the program management unit 102 determines whether there exist output variables where the control execution block 302 is not generated (Step S7).

If there exists an output variables where the control execution block 302 is not generated (YES in Step S7), the process proceeds to Step S8. On the other hand, if the control execution blocks 302 are generated for all output variables (NO in Step S7), the process proceeds to Step S10.

In Step S8, the program management unit 102 selects the next output variable.

More specifically, the program management unit 102 selects the next output variable following the output variable being the target for generation in the control execution block 302 immediately before in the control procedure data 200.

Next, the program management unit 102 generates a code block (control execution block 302) to decide the value to be assigned to the selected output variable that is selected (Step S9).

More specifically, the program management unit 102 generates the control execution block 302 to decide the value to be assigned to the selected output variable based on the value of the state variable of the associated condition to which the selected output variable corresponds.

As a specific example, description is directed to the operation of the program management unit 102 in Step S9 when the output variable Y10 is selected in Step S8.

In FIG. 4, the value of the output variable Y10 becomes ON (Step T2) when “X0==ON” being the associated condition is established (YES in Step T1). That is, the value of the output variable Y10 becomes ON when the value of the state variable M1 of the associated condition “X0==ON” is ON. Meanwhile, in FIG. 4, the value of the output variable Y10 becomes OFF (Step T4) when “X1==ON” being the associated condition is established (YES in Step T3). That is, the value of the output variable Y10 becomes OFF when the value of the state variable M2 of the associated condition “X1==ON” is ON. The program management unit 102 generates the control execution block 302 reflecting these control procedures.

Further, description is directed to the operation of the program management unit 102 in Step S9 when the output variable Y11 is selected in Step S8.

In FIG. 4, the value of the output variable Y11 becomes ON (Step T4) when the associated condition “X1==ON” is established (YES in Step T3). That is, the value of the output variable Y11 becomes ON when the value of the state variable M2 of the associated condition “X1==ON” is ON. Meanwhile, in FIG. 4, the value of the output variable Y11 becomes OFF (Step T6) when “X2==ON” being the associated condition is established (YES in Step T5). That is, the value of the output variable Y11 becomes OFF when the value of the state variable M3 of the associated condition “X2==ON” is ON. The program management unit 102 generates the control execution block 302 reflecting these control procedures.

Once control execution blocks 302 are generated for all output variables (NO in Step S7), the program management unit 102 combines all of the state determination blocks 301 and the control execution blocks 302, and generates a control program 300 that reflects the control procedures of the control procedure data 200 (Step S10).

The above has explained an example where the program management unit 102 generates the control execution block 302 in which the output variable turns ON and OFF once each, in Step S9. The program management unit 102 can also generate the control execution block 302 where the values of the output variables change more frequently.

For example, assume that in the control procedure data 200, there are two or more condition sets, which are combinations of two or more conditions, and that two or more condition sets are associated with the output variable. Further, assume that the said output variable is associated with conditions contained in each of the two or more condition sets as associated conditions. Herein, such output variable is referred to as a composite output variable. The composite output variable is an example of a composite control variable.

In such a case, suppose that the composite output variable is selected as the selected output variable. The program management unit 102 generates, for each condition set associated with the composite output variable, the control execution block 302 to decide the value to be assigned to the composite output variable based on the combination of the values of the state variables of the associated conditions included in the condition sets.

To be specific, assume that condition sets 1 through 3 are associated with the composite output variable Y1.

The condition set 1 shall contain a condition 1 (X1==ON″) and a condition 2 (“X2==OFF”). The condition set 2 shall contain a condition 3 (“X3==ON”) and a condition 4 (“X4 ==OFF”). The condition set 3 shall contain a condition 5 (“X5==ON”) and a condition 6 (“X6==OFF”).

In this case, assume that the program management unit 102 sets M1 as the state variable of the condition 1 (“X1==ON”), and M2 as the state variable of the condition 2 (“X2==OFF”). Further, assume that the program management unit 102 sets M3 as the state variable of the condition 3 (“X3==ON”), and M4 as the state variable of the condition 4 (“X4==OFF”). Furthermore, assume that the program management unit 102 sets M5 as the state variable of the condition 5 (“X5==ON”), and M6 as the state condition of the condition 6 (“X6==OFF”).

In such a case, the program management unit 102 generates, for each condition set, a control execution block 302 to decide the value to be assigned to the composite output variable Y1 based on the combination of the values of the state variables of the associated conditions included in the condition sets, as illustrated in FIG. 8.

Additionally, the program management unit 102 may generate a control execution block 302 to decide the value of the output variable that takes an integer value, not a 1-bit value.

For example, assume that two or more conditions are associated as the associated conditions, and an output variable to which the value to be assigned when the associated conditions are established varies depending on each associated condition is contained in the control procedure data 200. Here, such an output variable is referred to as a change output variable. The change output variable is an example of a change control variable.

In such a case, assume that the change output variable is selected as the selected output variable. The program management unit 102 generates a control execution block 302 to change the value to be assigned to the change output variable based on the value of the state variable of the associated condition for the change output variable.

Specifically, it is assumed that the change output variable D10 is associated with conditions 1 through 3. Further, if the condition 1 is established, the value 10 is assigned to the change output variable D10. Additionally, if the condition 2 is established, the value 20 is assigned to the change output variable D10. Further, if the condition 3 is established, the value 30 is assigned to the change output variable D10. In this case, the program management unit 102 sets the state variable M1 for the condition 1, the state variable M2 for the condition 2, and the state variable M3 for the condition 3.

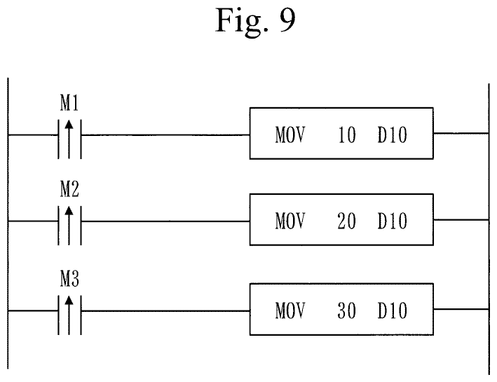

The control procedure data acquisition unit 101 generates a control execution block 302 to assign the value 10 to the change output variable D10 if the value of the state variable M1 is ON, assign the value 20 to the change output variable D10 if the value of state variable M2 is ON, and assign the value 30 to the change output variable D10 if the value of the state variable M3 is ON. The program management unit 102 generates, for each state variable, a control execution block 302 (expressed as a MOV instruction in FIG. 9) to change the value to be assigned to the change output variable D10, for example, as illustrated in FIG. 9.

Furthermore, not limited to simple value changes, the control procedure data 200 may define a process to call another code block such as a function block, for example. In this case, the program management unit 102 generates a control execution block 302 that includes a control variable to call a function block when conditions are established.

### *** Description of Effect of Embodiment ***

According to the present embodiment, it is possible to generate a control program that reflects the control procedure using state transition notation, thereby reducing development man-hours.

In other words, in the present embodiment, a program developer only needs to create control procedure data that includes descriptions of conditions and control processes corresponding to the success or failure of the conditions, and then a control program that reflects the control procedure can be generated in a familiar format (state transition notation). Therefore, the present embodiment allows reduction of development man-hours for control program of manufacturing equipment while maintaining the maintainability of the manufacturing equipment.

### Second Embodiment

In First Embodiment, description has been made on an example of generating the control program 300 in state transition notation. In the present embodiment, an example of generating the control program 300 in event control notation will be described.

The present embodiment will mainly describe the differences with First Embodiment.

Note that the matters that are not described hereinafter are the same as those in First Embodiment.

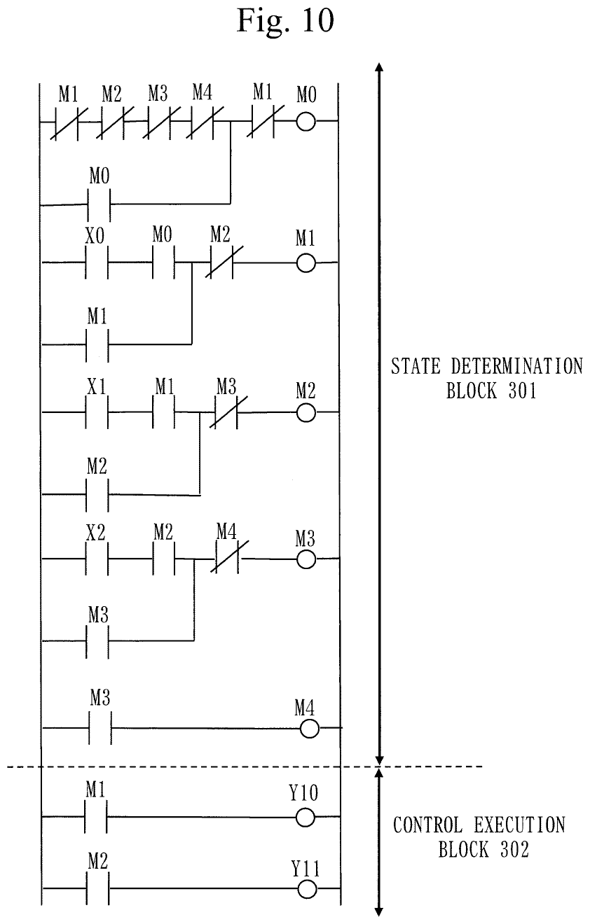

FIG. 10 illustrates the control program 300 in event control notation.

Hereinafter, description will be made on an example where the program management unit 102 generates the control program 300 illustrated in FIG. 10 by executing the processing flow of FIG. 6 on the control procedure data 200 in FIG. 4.

In addition, the following will mainly describe the processes that are different from those in First Embodiment.

In Step S5, the program management unit 102 generates a state determination block 301 to decide the value of the state variable of the selected condition based on the success or failure of the selected condition, the values of state variables of the preceding conditions, and the values of state variables of the conditions with the order subsequent to the selected condition.

Here, description will be made on details of the operation of the program management unit 102 in Step S5 using an example of generating the state determination block 301 to decide the state variable of the selected condition “X0==ON”.

Here, the control procedure data 200 is supposed to have a definition that the condition by which the state variable of the selected condition is not established is the value of the state variable of the condition immediately subsequent to the selected condition becomes ON.

Therefore, the program management unit 102 generates a state determination block 301 where the value of the state variable M1 of the selected condition “X0==ON” becomes OFF when the value of the state variable M2 of “X1==ON” being the condition immediately subsequent to the selected condition “X0 ==ON”.

The state variable M0 of the condition (starting point) immediately prior to the selected condition “X0==ON” is a condition which makes the value of the state variable M1 become ON. However, the program management unit 102 generates the state determination block 301 so that the state variable M0 does not become a condition which makes the value of the state variable M1 become OFF in contrast to First Embodiment (state transition notation).

In Step S2, the program management unit 102 generates a state determination block 301 where the value of the state variable M0 in the starting point becomes ON when the values of state variables M1 through M4 are not ON, in other words, in their initial states, and similarly as the process in Step S5, the value of the state variable MO becomes OFF when the state variable M1 of the immediately subsequent condition turns ON.

Note that, in FIG. 10, the determination process of the state variable M1 is redundantly described to simplify the representation of the state determination block 301. The program management unit 102 does not necessarily have to generate the unnecessary determination process for the state variable M1 on the left.

In the case of event control notation, when the value of the state variable of the next condition is ON, the value of the state variable of the previous condition is OFF. Therefore, if the selected output variable is a bit type variable, the program management unit 102 generates the control execution block 302 only with the state variable where the value of the bit-type variable becomes ON in Step S9. In the example of FIG. 4, the value of the output variable Y10 becomes ON only when the value of the state variable M1 of the condition “X0==ON” is ON. Further, the value of the output variable Y11 becomes ON only when the value of the state variable M2 of the condition “X1==ON” is ON. As illustrated in FIG. 10, the program management unit 102 generates the control execution block 302 of the output variable Y10 and the control execution block 302 of the output variable Y11 in such a manner that this control procedure is reflected.

As described above, according to the present embodiment, a control program reflecting the control procedure can be generated in event control notation, which facilitates reduction in development man-hours.

Additionally, in First Embodiment and Second Embodiment, description has been made on examples where the program management unit 102 generates the control program in ladder language. The program management unit 102 can also generate a control program in a language other than ladder language.

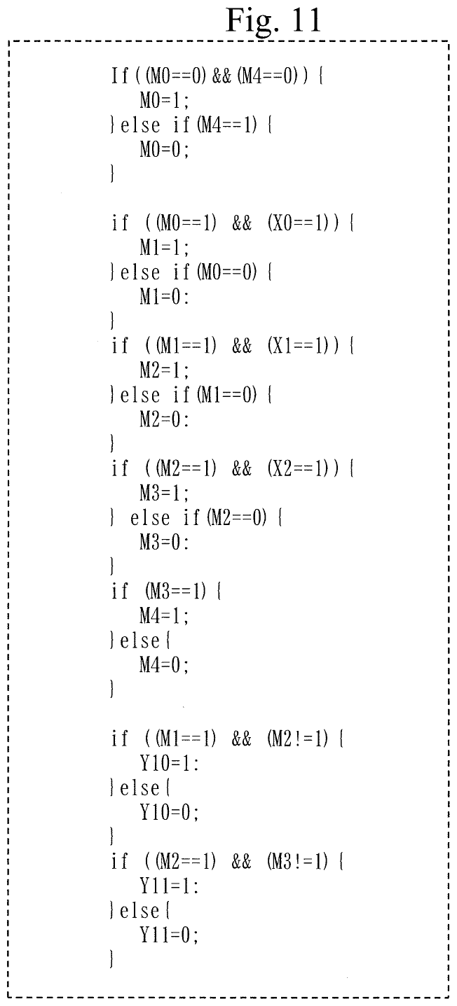

FIG. 11 illustrates an example of the control program 300 in C language, which the program management unit 102 has generated by executing the processing flow of FIG. 6 on the control procedure data 200 of FIG. 4.

It should be noted that FIG. 11 illustrates code blocks reflecting only the conditions 201 and the control processes 202 defined by the control procedure data 200. In other words, FIG. 11 omits the representation of such things as definitions of variable names, and so on.

The user of the data processing device 100 can specify the type of the control program 300 (the state determination block 301, the control execution block 302) generated by the program management unit 102. That is, the user can specify in which notation of state transition notation, event control notation, C language, etc., the control program 300 is to be generated.

The user of the data processing device 100 inputs a command that specifies the type of the control program 300 in the operation unit 104 through an input and output device 904, for example. The operation unit 104 obtains the command, and notifies the program management unit 102 of the type of the control program 300.

The program management unit 102 generates the control program 300 that corresponds to the type notified from the operation unit 104. In other words, if the user specifies the state transition notation as the type of the control program 300, the program management unit 102 generates the control program 300 by the method described in First Embodiment. On the other hand, if the user specifies the event control notation as the type of the control program 300, the program management unit 102 generates the control program 300 by the method described in Second Embodiment.

Additionally, the user can make another choice, for instance, on whether or not to set conditions by which the state variable is not established. For example, the user can input a command directing such a choice in the operation unit 104. Furthermore, the user may make this sort of choice in the control procedure data 200. A user interface that allows for such a choice may also be provided in the display unit 103.

The program management unit 102 generates the control program 300 that matches the choice of the user.

### Third Embodiment

A control program which controls manufacturing equipment is often required to enable initialization of states, forced stoppage of operation of the manufacturing equipment, maintenance of variable values at the time when problems occur, and so on. Therefore, in the present embodiment, the program management unit 102 generates the control program 300 to handle these requirements.

In the present embodiment, the differences from First Embodiment will mainly be described.

Matters not described below are similar to those in First Embodiment.

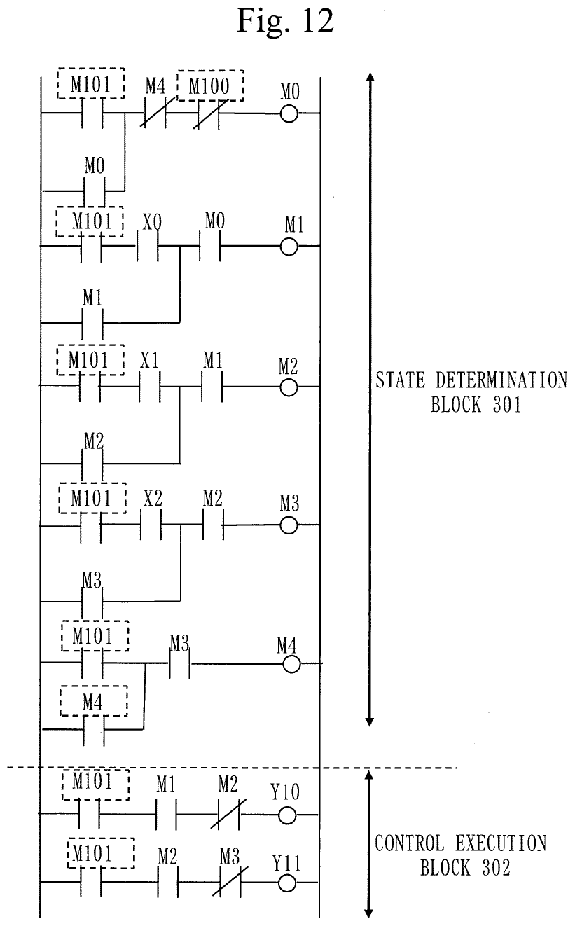

FIG. 12 illustrates an example of the control program 300 in state transition notation according to the present embodiment.

In FIG. 12, variables enclosed by dashed lines are added compared to FIG. 5. Specifically, in FIG. 12, when the value of variable M100 becomes ON, all state variables are initialized. In addition, in FIG. 12, when the value of variable M101 becomes OFF, values of all state variables are fixed, and the progresses of states stop. Moreover, when the value of the variable M101 becomes OFF, the values of the output variable Y10 and the output variable Y11 are forced to become OFF, and the operation of the piston stops.

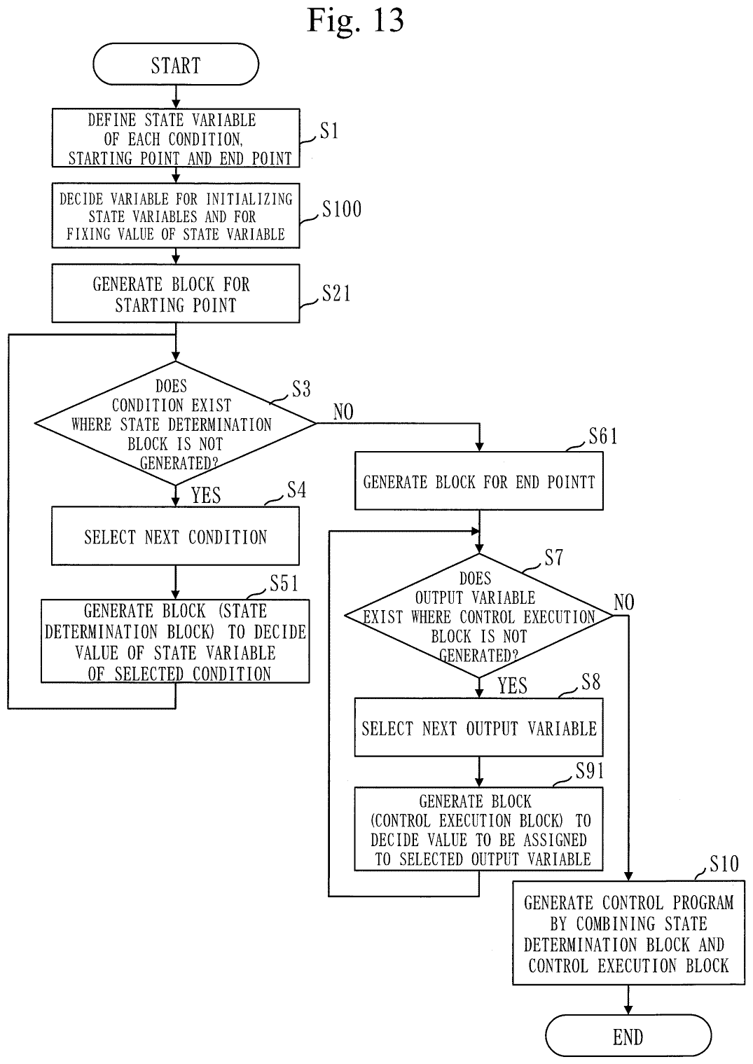

FIG. 13 is a flowchart describing an example of the operation when the program management unit 102 generates the control program 300 illustrated in FIG. 12.

In FIG. 13, Step S100, Step S21, Step S51, Step S61 and Step S91 are different compared to FIG. 6.

Hereinafter, these differences will be mainly described.

In Step S100, the program management unit 102 decides variables for initialization of state variables and fixation of values of state variables.

In the example of FIG. 12, the program management unit 102 decides M100 as a variable for initialization (hereinafter referred to as an initialization variable). Moreover, the program management unit 102 decides M101 as a variable for fixing the values of state variables (hereinafter referred to as a fixation variable).

The variable names for the initialization variable and the fixation variable may be automatically assigned by the program management unit 102, or may be specified beforehand by the user in the control procedure data 200, for example.

Furthermore, in the example of FIG. 12, since values of all state variables are uniformly fixed, the program management unit 102 decides just a single fixation variable. Unlike this case, the program management unit 102 may decide a plurality of fixation variables in order to partition the range of fixation. For instance, the user may specify the range in which variable values are simultaneously fixed in the control procedure data 200. Then, the program management unit 102 decides the fixation variables for each range specified by the user.

In step S21, as a block (state determination block 301) for the starting point, a block in which the value of the state variable M0 becomes OFF when the value of the initialization variable M100 becomes ON is generated. With the value of the state variable M0 in the starting point becoming OFF, the values of the state variables M1 through M4 sequentially become OFF. As a result, initialization of all state variables is realized.

Furthermore, the program management unit 102 adds the fixation variable 101 to the state determination block 301 in the starting point so that the value of the state variable M0 does not become ON when the value of the state variable M0 is OFF and the fixation variable M101 is OFF. In this manner, the value of the state variable M0 does not become ON when the value of the fixation variable M101 is OFF. This makes it possible to stop control from progressing while maintaining the state.

In step S51, the program management unit 102 generates a block (state determination block 301) that prevents the state variables M1 through M3 from becoming ON when the values of the state variables M1 through M3 are OFF and the value of the fixation variable M101 is OFF, as with Step S21.

Similarly in Step S61, the program management unit 102 generates a block (state determination block 301) that prevents the value of the state variable M4 from becoming ON when the value of the state variable M4 is OFF and the value of the fixation variable M101 is OFF. Further, in order to make the other processing unchanged, the program management unit 102 ensures that the value of the state variable M4 remains ON when the values of both the state variable M3 and the state variable M4 are ON.

In Step S91, the program management unit 102 generates a block (control execution block 302) that sets the values of the output variable Y10 and the output variable Y11 to OFF when the value of the fixation variable M101 is OFF. This allows the piston to be stopped regardless of the state in which the value of the fixation variable M101 becomes OFF.

In the present embodiment, description has been made on the example where the program management unit 102 generates a block that forcibly turns OFF the values of all output variables when the value of the fixation variable M101 becomes OFF.

Instead, the program management unit 102 may generate a control execution block 302 that forcibly turns OFF only the values of the output variables specified. In this case, the user specifies the output variable to be targeted, for example, in the control procedure data 200. Then, the program management unit 102 generates the control execution block 302 that forcibly turns OFF the value of the output variable specified in the control procedure data 200.

Furthermore, the program management unit 102 may generate a control execution block 302 that switches an output variable of which the value is forcibly turned OFF. In this case, the user specifies the switch condition of the output variable in the control procedure data 200, for example. Then, the program management unit 102 generates the control execution block 302 that switches the output variable of which the value is forcibly turned OFF according to the switch condition.

Additionally, the program management unit 102 may generate a control execution block 302 which forcibly changes the value of output variable to a preset value except for OFF. In this case, the user specifies the value of the output variable after the forced change, for example, in the control procedure data 200. Then, the program management unit 102 generates the control execution block 302 that forcibly changes the value of the output variable to the value specified in the control procedure data 200.

Further, in the present embodiment, description has been made on the example where the program management unit 102 uses the initialization variable and the fixed variable; however, the program management unit 102 may use the other variables.

The program management unit 102 may always use such variables to generate the control program 300. Furthermore, the user may specify whether to use these variables in the control procedure data 200, and the program management unit 102 may generate the control program 300 by using the variables according to the specification in the control procedure data 200.

As described above, according to the present embodiment, it is possible to generate a control program capable of initializing states, forcibly stopping the operation of manufacturing equipment, maintaining the states of variables when problems occur, and so on. As a result, this reduces the development man-hours for the control program.

### Fourth Embodiment

As for control over manufacturing equipment, control may be switched depending on the conditions. In the present embodiment, by taking such cases into consideration, the program management unit 102 generates a control program 300 corresponding to the control procedure data 200 in which branching and merging are defined.

In the present embodiment, mainly the differences from First Embodiment are described.

Any items not described below are similar to those in First Embodiment.

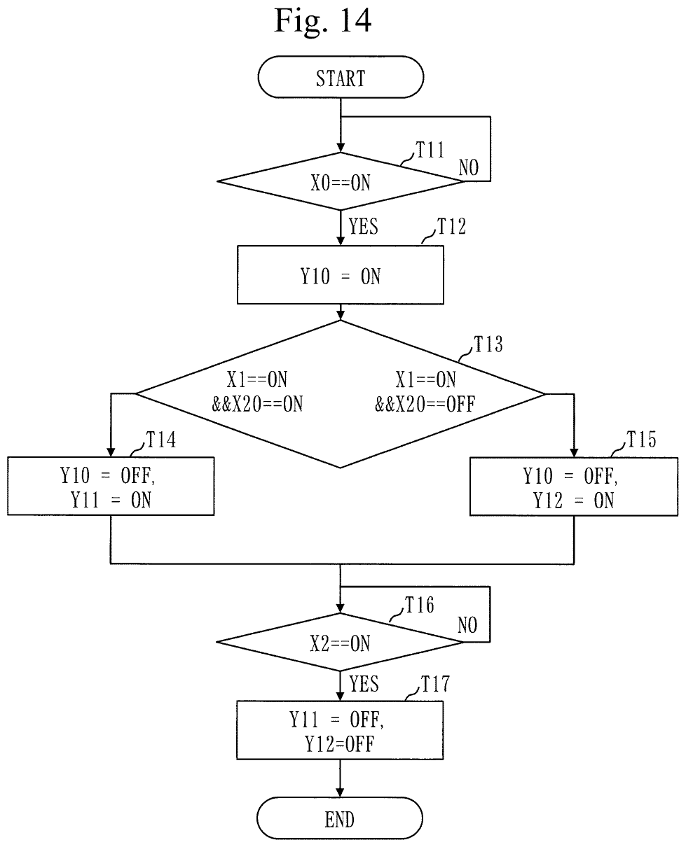

FIG. 14 illustrates an example of the control procedure data 200 that includes branch conditions and merging conditions.

Step T11 and Step T12 in FIG. 14 are the same as Step T1 and Step T2 in FIG. 4.

In Step T13 in FIG. 14, if it is determined that the condition “X1==ON” and the condition “X20==ON” are established, the value of the output variable Y10 becomes OFF, and the value of the output variable Y 11 becomes ON (Step T14). Meanwhile, if it is determined that the condition “X1==ON” and the condition “X20==OFF” are established, the value of the output variable Y10 becomes OFF, and the value of the output variable Y12 becomes ON (Step T15).

Then, if the condition “X2==ON” is established even when either Step T14 or Step T15 is executed (YES in Step T16), the value of the output variable Y11 and the value of the output variable Y12 become OFF (Step T17).

In FIG. 14, a branch occur by “X1==ON && X20==ON” and “X1==ON && X20==OFF” in Step T13, and these are branch conditions.

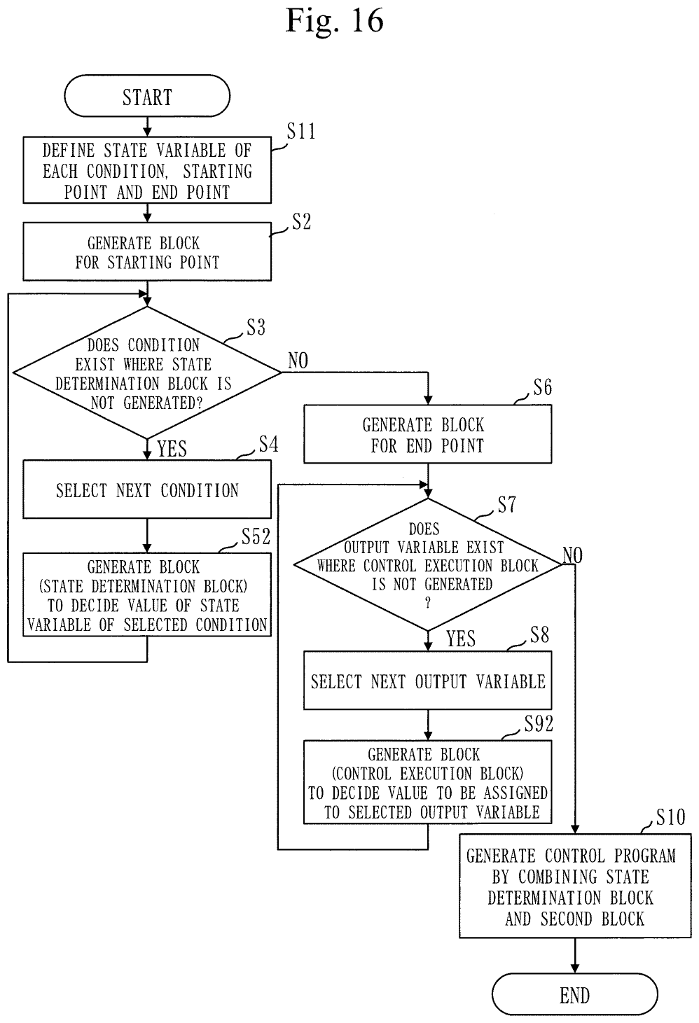

Further, the branch merges when the condition “X2==ON” in Step 16 is established. Therefore, the condition “X2==ON” in FIG. 16 is a merging condition.

Further, a plurality of routes up to the branch generated by the branch conditions merges are called branch routes. In FIG. 14, each of the route from Step T13 to Step T16 via Step T14 and the route from Step T13 to Step T16 via Step T15 is the branch route.

Furthermore, the value of the output variable Y11 depends on establishment of the branch condition “X1==ON && X20==ON” in Step T14. Meanwhile, the value of the output variable Y11 depends on establishment of the merging condition “X2==ON” in Step T17. Therefore, the branch condition “X1==ON && X20==ON” and the merging condition “X2==ON” are associated conditions of the output variable Y11.

Similarly, the value of the output variable Y12 depends on establishment of the branch condition “X1==ON && X20=OFF” in Step T15. Meanwhile, the value of the output variable Y12 depends on establishment of the merging condition “X2==ON” in Step T17. Therefore, the branch condition “X1==ON && X20 ==OFF” and the merging condition “X2==ON” are associated conditions of the output variable Y12.

For the output variable Y11 and the output variable Y12, the branch condition and the merging condition are the associated conditions, and correspond to a synthesis output variable. The synthesis output variable is an example of the synthesis control variable.

On the other hand, for the output variable Y10, the branch condition “X1==ON && X20==ON” or “X1==ON && X20==OFF” is the associated condition while the synthesis condition “X2==ON” is not the associated condition. Therefore, the output variable Y10 does not correspond to the synthesis output variable.

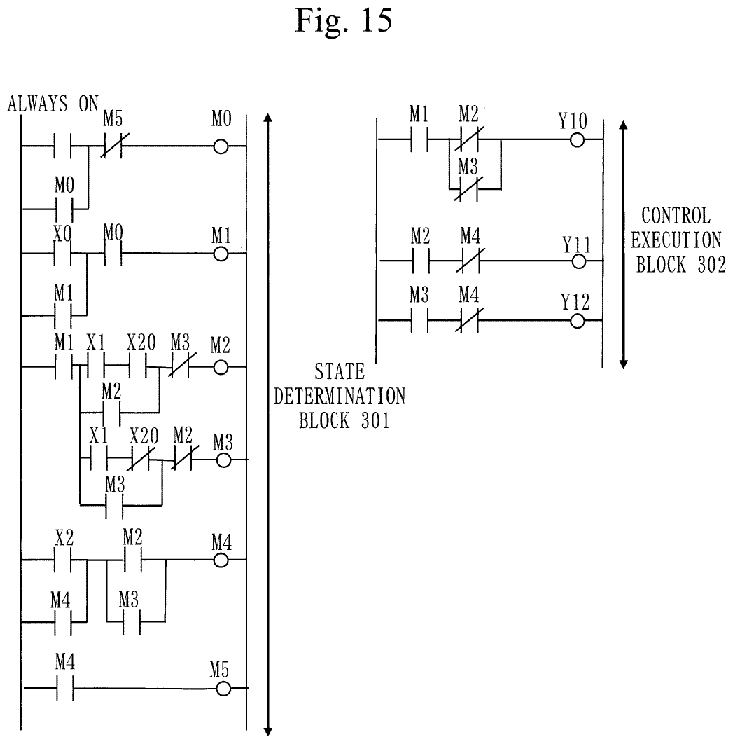

FIG. 15 illustrates an example of the control program 300 in state transition notation generated from the control procedure data 200 illustrated in FIG. 14.

In the following, description will be made on a procedure to generate the control program 300 illustrated in FIG. 15 from the control procedure data 200 illustrated in FIG. 14 by the program management unit 102, using FIG. 16.

In FIG. 15, Step S11, Step S52, and Step S92 are different compared to FIG. 6.

In the following, these steps will be mainly described.

In step S11, similarly to Step S1 in FIG. 6, state variables are defined for each condition, the starting point, and the end point. In Step S11, when the control procedure data 200 includes a branch condition, the program management unit 102 defines a state variable indicating the success or failure of the branch condition for the branch condition. Meanwhile, when the control procedure data 200 includes a merging condition, the program management unit 102 defines a state variable indicating the success or failure of the merging condition for the merging condition.

In the example of FIG. 15, the program management unit 102 defines the state variable M0 for the starting point. Additionally, the program management unit 102 defines the state variable M1 for the condition “X0==ON”. Further, the program management unit 102 defines the state variable M2 for the branch condition “X1==ON && X20==ON”. Furthermore, the program management unit 102 defines the state variable M3 for the branch condition “X1==ON && X20==OFF”. In addition, the program management unit 102 defines the state variable M4 for the merging condition “X2==ON”. Further, the program management unit 102 defines the state variable M5 for the end point.

In Step S52, when the selected condition is a branch condition, the program management unit 102 generates a code block (state determination block 301) to decide the value of the state variable of the branch condition (referred to as a selected branch condition) being the selected condition based on the success or failure of the selected branch condition, the value of the state variable of the preceding condition of the selected branch condition, and the value of the state variable of another branch condition.

More specifically, the program management unit 102 generates the state determination block 301 where the state variable of the selected branch condition turns ON when the selected branch condition is established, the value of the state variable of the condition immediately prior to the selected branch condition is ON, and the state variable of the other branch condition is OFF. In other words, the program management unit 102 generates the state determination block 301 where the state variable of the selected branch condition turns ON and the state variable of the other branch condition turns OFF when the selected branch condition is established and the value of the state variable of the condition immediately prior to the selected branch condition is ON.

In FIG. 15, when the selected branch condition “X1==ON && X20==ON” is established and when the value of the state variable Ml of the immediately preceding condition is ON and the value of the state variable M3 of the other branch condition “X ==ON && X20==OFF” is OFF, the value of the state variable M2 of the selected branch condition “X1==ON && X20 ==ON” becomes ON.

That is, the program management unit 102 generates the state determination block 301 where the value of the state variable M3 does not become ON when the value of the state variable M2 become ON beforehand, and on the contrary, the value of the state variable M2 does not become ON when the value of the state variable M3 becomes ON beforehand.

In FIG. 15, the success/failure determination process for the state variable M1 of the immediately preceding condition is shared between the success/failure determination process for the state variable M2 and the success/failure determination process for the state variable M3. Alternatively, the program management unit 102 may generate the state determination block 301 to perform the success/failure determination process for the state variable M1 individually in the success/failure determination process of the state variable M2 and the success/failure determination process of the state variable M3.

Furthermore, in Step S52, when the selected condition is a merging condition, the program management unit 102 generates a code block (state determination block 301) that decides the value of the state variable of the merging condition based on the success or failure of the merging condition, and the value of the state variable of the condition contained in the plurality of branch routes or the values of the state variables of the plurality of branch conditions.

More specifically, the program management unit 102 generates the state determination block 301 that sets the state variable of the merging condition to ON when the merging condition is established, and the value of the state variable of any condition contained in any of the plurality of branch routes prior to merging or the value of any state variable of the plurality of branch conditions is ON.

In FIG. 15, when the merging condition “X2==ON” is established, and either value of the state variable M2 and the state variable M3 of two branch conditions is ON, the value of the state variable M4 of the merging condition becomes ON. In the control procedure data 200 of FIG. 14, no condition exists on any branch route. Therefore, in FIG. 15, the value of the state variable M4 of the merging condition “X2==ON” becomes ON when the merging condition is established, and any value of the state variable M2 and the state variable M3 is ON.

In addition, although FIG. 14 illustrates an example where multiple branch routes merge when a certain condition is established, even in a case where multiple branch routes merge in the control process, the program management unit 102 generates the state determination block 301 through a similar procedure.

For instance, even in an example where the control process “Y13=ON” is indicated between Step T14 and Step T16 and further between Step T15 and Step T16 in FIG. 14, and the plurality of branch routes merge in the control process “Y13=ON”, the program management unit 102 generates the state determination block 301 through a similar procedure.

In Step S92, the program management unit 102 generates a code block (control execution block 302) to decide the value to be assigned to the selected output variable in accordance with the control procedure, similarly to First Embodiment.

In the present embodiment, when the selected control variable is a synthesis output variable, the program management unit 102 generates a code block (control execution block 302) to decide the value to be assigned to the synthesis output variable based on the value of the state variable of the branch condition (associated condition of the synthesis output variable) and the value of the state variable of the merging condition (associated condition of the synthesis output variable).

In a case where the selected output variable is not a synthesis output variable, the program management unit 102 generates the control execution block 302 in a manner similar to First Embodiment.

In the example of FIG. 15, the value of the output variable Y10 not being a synthesis output variable becomes ON when the state variable M1 of the condition “X0==ON” is ON. Meanwhile, the value of the output variable Y10 becomes OFF when either the state variable M2 of the branch condition “X1==ON && X20==ON” or the state variable M3 of the branch condition “X1==ON && X20==OFF” is ON.

Further, the value of the output variable Y11 being a synthesis output variable becomes ON when the value of the state variable M2 of the branch condition “X1==ON && X20==ON” is ON. Meanwhile, the value of the output variable Y11 becomes OFF when the state variable M4 of the merging condition “X2==ON” is ON. Furthermore, the value of the output variable Y12 being a synthesis output variable becomes ON when the value of the state variable M3 of the branch condition “X1==ON && X20==OFF” is ON. Meanwhile, the value of the output variable Y12 becomes OFF when the state variable M4 of the merging condition “X2==ON” is ON.

As described above, according to the present embodiment, a control program can be generated from control procedure data in which branching and merging are defined, which can reduce the development man-hours of the control program.

In the above, First Embodiment through Fourth Embodiment have been described; however, any two or more of these embodiments can be combined and implemented.

Alternatively, one of these embodiments may be partially implemented.

Alternatively, two or more of these embodiments may be partially implemented in combination.

In addition, the configurations and the procedures described in these embodiments may be modified as necessary.

### ***Supplemental Description of Hardware Configuration***

Finally, supplemental description for the hardware configuration of the data processing device 100 will be provided.

The processor 901 illustrated in FIG. 2 is an integrated circuit (IC) that performs processing.

The processor 901 is a CPU (Central Processing Unit), a DSP (Digital Signal Processor) or the like.

The main storage device 902 illustrated in FIG. 2 is a RAM (Random Access Memory).

The auxiliary storage device 903 illustrated in FIG. 2 is a ROM (Read-Only Memory), a flash memory, an HDD (Hard Disk Drive) or the like.

The input and output device 904 illustrated in FIG. 2 is a mouse, a keyboard, a display or the like.

The data processing device 100 may also include a communication device, which is not illustrated in FIG. 2. The communication device is an electronic circuit that executes data communication processing. The communication device is, for instance, a communication chip or an NIC (Network Interface Card).

Further, the auxiliary storage device 903 stores an OS (Operating System).

Then, at least part of the OS is executed by the processor 901.

While executing at least part of the OS, the processor 901 executes programs to realize the functions of the control procedure data acquisition unit 101, the program management unit 102, the display unit 103 and the operation unit 104.

By executing the OS by the processor 901, task management, memory management, file management, communication control and the like are performed.

Furthermore, at least any of the information, data, signal values, and variable values indicating the results of the processing by the control procedure data acquisition unit 101, the program management unit 102, the display unit 103 and the operation unit 104 is stored in at least any of the main storage device 902, the auxiliary storage device 903, a register and cache memory inside the processor 901.

Additionally, the programs to realize the functions of the control procedure data acquisition unit 101, the program management unit 102, the display unit 103 and the operation unit 104 may be stored in a portable recording medium such as a magnetic disk, a flexible disk, an optical disc, a compact disc, a Blue-ray (registered trademark) disc, a DVD or the like. Furthermore, it is permissible to distribute a portable recording medium in which the programs to realize the functions of the control procedure data acquisition unit 101, the program management unit 102, the display unit 103 and the operation unit 104 are stored.

Further, at least any “unit” of the control procedure data acquisition unit 101, the program management unit 102, the display unit 103 and the operation unit 104 may be replaced with “circuit”, “step”, “procedure”, “process” or “circuitry”.

Furthermore, the data processing device 100 may be realized by a processing circuit. The processing circuit is, for instance, a logic IC (Integrated Circuit), a GA (Gate Array), an ASIC (Application Specific Integrated Circuit) or an FPGA (Field-Programmable Gate Array).

In this case, the control procedure data acquisition unit 101, the program management unit 102, the display unit 103 and the operation unit 104 are each realized as part of the processing circuit.

In the present specification, a superordinate concept of the processor and the processing circuit is called “processing circuitry”.

That is, each of the processor and the processing circuit is a concrete example of “processing circuitry”.

### REFERENCE SIGNS LIST

100: data processing device; 101: control procedure data acquisition unit; 102: program management unit; 103: display unit; 104: operation unit; 200: control procedure data; 201: condition; 202: control process; 300: control program; 301: state determination block; 302: control execution block; 901: processor; 902: main storage device; 903: auxiliary storage device; 904: input and output device

1. A data processing device comprising:
processing circuitry:
to acquire control procedure data indicating a control procedure using a plurality of conditions that are ordered, and a plurality of control variables, each of which is associated with any of the plurality of conditions, and to which a value is assigned depending on success or failure of an associated condition being the condition that is associated;
to sequentially select each condition of the plurality of conditions, and to generate, for each selected condition being the condition selected, a first partial program to decide a value of a state variable of the selected condition based on success or failure of the selected condition and a value of a state variable of a preceding condition being a condition with an order prior to the selected condition, in accordance with the control procedure;
to sequentially select each control variable of the plurality of control variables, and to generate, for each selected control variable being the control variable selected, a second partial program to decide a value to be assigned to the selected control variable based on a value of a state variable of the associated condition for the selected control variable, in accordance with the control procedure; and
to generate a program that reflects the control procedure using the first partial program and the second partial program.

2. The data processing device as defined in claim 1, wherein the processing circuitry generates the first partial program to decide the value of the state variable of the selected condition based on the success or failure of the selected condition and a value of a state variable of a condition with an order immediately prior to the selected condition.

3. The data processing device as defined in claim 1, wherein the processing circuitry generates a state variable of a starting point of the control procedure, and
when a condition with an earliest order among the plurality of conditions is the selected condition, the processing circuitry generates the first partial program to decide a value of a state variable of the condition with the earliest order being the selected condition based on success or failure of the condition with the earliest order being the selected condition and a value of the state variable of the starting point.

4. The data processing device as defined in claim 3, wherein the processing circuitry generates a state variable of an end point of the control procedure, and
the processing circuitry generates the first partial program to decide the value of the state variable of the starting point based on a value of the state variable of the end point.

5. The data processing device as defined in claim 1, wherein the processing circuitry generates the first partial program to decide the value of the state variable of the selected condition based on the success or failure of the selected condition or the value of the state variable of the selected condition, and the value of the state variable of the preceding condition.

6. The data processing device as defined in claim 1, wherein the processing circuitry acquires the control procedure data where a condition accompanying a logical operation of a plurality of partial conditions is included in the plurality of conditions, and wherein
when the condition accompanying the logical operation of the plurality of partial conditions is the selected condition, the processing circuitry generates the first partial program to decide the value of the state variable of the selected condition based on the success or failure of the selected condition based on a result of the logical operation of the plurality of partial conditions, and the value of the state variable of the preceding condition.

7. The data processing device as defined in claim 1, wherein the processing circuitry acquires the control procedure data where a condition accompanying a determination on whether a timer has expired is included in the plurality of conditions, and
when the condition accompanying the determination on whether the timer has expired is the selected condition, the processing circuitry generates the first partial program to decide the value of the state variable of the selected condition based on the success or failure of the selected condition based on a determination result of whether the timer has expired, and the value of the state variable of the preceding condition.

8. The data processing device as defined in claim 1, wherein the processing circuitry acquires the control procedure data where a composite control variable being a control variable with which two or more condition sets, each of which being a combination of two or more conditions, are associated, and with which a condition included in each of the two or more condition sets is associated as the associated condition, is included in the plurality of control variables, and wherein
when the composite control variable is the selected control variable, the processing circuitry generates, for each of the two or more condition sets associated with the composite control variable, the second partial program to decide a value to be assigned to the composite control variable based on a combination of values of state variables of the associated condition included in the condition sets.

9. The data processing device as defined in claim 1, wherein the processing circuitry acquires the control procedure data where a change control variable being a control variable, with which two or more conditions are associated as associated conditions, and to which a value to be assigned when the associated conditions are established varies depending on each of the associated conditions, is included in the plurality of control variables, and
when the change control variable is the selected control variable, the processing circuitry generates the second partial program to change the value to be assigned to the change control variable based on values of state variables of the associated conditions for the change control variable.

10. The data processing device as defined in claim 1 wherein the processing circuitry generates the first partial program to decide the value of the state variable of the selected condition based on the success or failure of the selected condition, the value of the state variable of the preceding condition, and a value of a state variable of a condition with an order subsequent to the selected condition.

11. The data processing device as defined in claim 10, wherein the processing circuitry generates the first partial program to decide the value of the state variable of the selected condition based on the success or failure of the selected condition, the value of the state variable of the preceding condition, and a value of a state variable of a condition with an order immediately subsequent to the selected condition.

12. The data processing device as defined in claim 1, wherein the processing circuitry generates the first partial program to initialize all state variables of the plurality of conditions.

13. The data processing device as defined in claim 1, wherein the processing circuitry generates the first partial program to fix values of all state variables of the plurality of conditions, or a value of a state variable specified among the state variables of the plurality of conditions.

14. The data processing device as defined in claim 1, wherein the processing circuitry generates the second partial program to make all values of the plurality of control variables or a value of a control variable specified among the plurality of control variables be a predetermined value.

15. The data processing device as defined in claim 14, wherein when the second partial program to make the value of the control variable specified among the plurality of control variables be the predetermined value is generated, the processing circuitry generates the second partial program to switch the control variable made to be the predetermined value.

16. The data processing device as defined in claim 1, wherein the processing circuitry acquires the control procedure data in which a plurality of branch conditions generating a plurality of branch routes, and a merging condition under which the plurality of branch routes merge are included in the plurality of conditions, and a synthesis control variable being a control variable with which any of the plurality of branch conditions and the merging condition are associated as the associated condition is included in the plurality of control variables,
when any of the plurality of branch conditions is the selected condition, the processing circuitry generates the first partial program to decide a value of a state variable of the branch condition being the selected condition based on success or failure of the branch condition being the selected condition, the value of the state variable of the preceding condition of the branch condition being the selected condition, and a value of a state variable of a branch condition other than the branch condition being the selected condition,
when the merging condition is the selected condition, the processing circuitry generates the first partial program to decide a value of a state variable of the merging condition being the selected condition based on success or failure of the merging condition being the selected condition, and a value of a state variable of a condition included in the plurality of branch routes or a value of a state variable of the plurality of branch conditions, and
when the synthesis control variable is the selected control variable, the processing circuitry generates the second partial program to decide a value to be assigned to the synthesis control variable being the selected control variable based on the value of the state variable of the branch condition and the value of the state variable of the merging condition being the associated condition for the synthesis control variable being the selected control variable.

17. The data processing device as defined in claim 1, wherein the processing circuitry acquires a command to specify a program type of the first partial program and the second partial program,
wherein the processing circuitry generates the first partial program that conforms to the program type specified by the command, and
wherein the processing circuitry generates the second partial program that conforms to the program type specified by the command.

18. data processing method comprising:
acquiring control procedure data indicating a control procedure using a plurality of conditions that are ordered, and a plurality of control variables, each of which is associated with any of the plurality of conditions, and to which a value is assigned depending on success or failure of an associated condition being the condition that is associated;
sequentially selecting each condition of the plurality of conditions, and generating, for each selected condition being the condition selected, a first partial program to decide a value of a state variable of the selected condition based on success or failure of the selected condition and a value of a state variable of a preceding condition being a condition with an order prior to the selected condition, in accordance with the control procedure;
sequentially selecting each control variable of the plurality of control variables, and generating, for each selected control variable being the control variable selected, a second partial program to decide a value to be assigned to the selected control variable based on a value of a state variable of the associated condition for the selected control variable, in accordance with the control procedure; and
generating a program that reflects the control procedure using the first partial program and the second partial program.

19. A non-transitory computer readable medium storing a data processing program to cause a computer to execute:
a control procedure data acquisition process to acquire control procedure data indicating a control procedure using a plurality of conditions that are ordered, and a plurality of control variables, each of which is associated with any of the plurality of conditions, and to which a value is assigned depending on success or failure of an associated condition being the condition that is associated;
a first partial program generation process to sequentially select each condition of the plurality of conditions, and to generate, for each selected condition being the condition selected, a first partial program to decide a value of a state variable of the selected condition based on success or failure of the selected condition and a value of a state variable of a preceding condition being a condition with an order prior to the selected condition, in accordance with the control procedure;
a second partial program generation process to sequentially select each control variable of the plurality of control variables, and to generate, for each selected control variable being the control variable selected, a second partial program to decide a value to be assigned to the selected control variable based on a value of a state variable of the associated condition for the selected control variable, in accordance with the control procedure; and
a program generation process to generate a program that reflects the control procedure using the first partial program and the second partial program.
